(19) United States
(12) Patent Application Publication
(10) Pub. No.: US 2026/0050667 A1
(43) Pub. Date: Feb. 19, 2026

(54) TECHNIQUES FOR SECURITY EVENT REPORTING

(71) Applicant: QUALCOMM Incorporated, San Diego, CA (US)

(72) Inventors: Soo Bum LEE, San Diego, CA (US); Gavin Bernard HORN, La Jolla, CA (US); Hongil KIM, San Diego, CA (US)

(21) Appl. No.: 18/809,160

(22) Filed: Aug. 19, 2024

(51) Int. Cl. G06F 21/55; H04W 12/121

(52) U.S. Cl. CPC G06F 21/554; H04W 12/121

(57) ABSTRACT

Methods, systems, and devices for wireless communications are described. One or more wireless communication devices in a wireless communications system may support security event detection and reporting. A user equipment (UE) may detect occurrence of a security event that is indicative of an attack against a security vulnerability associated with the UE. The detection of the occurrence of the security event may be based on data collected by the UE. The UE may transmit, to a wireless entity and based on the detection of the security event, information indicative of the occurrence of the security event, the information representative of at least the data collected by the UE that triggered detection of the security event. A network entity may receive the information indicative of the security event and perform a security operation corresponding to the security event.

### FIELD OF TECHNOLOGY

The following relates to wireless communications, including techniques for security event reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). One or more wireless communications devices in a wireless communications system may be involved in or subject to a security event, a security threat, or the like.

### SUMMARY

The systems, methods, and devices of this disclosure each have several innovative aspects, no single one of which is solely responsible for the desirable attributes disclosed herein.

A method for wireless communications by a user equipment (UE) is described. The method may include detecting occurrence of a security event that is indicative of an attack against a security vulnerability associated with the UE, where detection of the occurrence of the security event is based on data collected by the UE and transmitting, to a wireless entity and based on detection of the security event, information indicative of the occurrence of the security event, the information representative of at least the data collected by the UE that triggered detection of the security event.

A UE for wireless communications is described. The UE may include one or more memories storing processor executable code, and one or more processors coupled with the one or more memories. The one or more processors may individually or collectively be operable to execute the code to cause the UE to detect occurrence of a security event that is indicative of an attack against a security vulnerability associated with the UE, where detection of the occurrence of the security event is based on data collected by the UE and transmit, to a wireless entity and based on detection of the security event, information indicative of the occurrence of the security event, the information representative of at least the data collected by the UE that triggered detection of the security event.

Another UE for wireless communications is described. The UE may include means for detecting occurrence of a security event that is indicative of an attack against a security vulnerability associated with the UE, where detection of the occurrence of the security event is based on data collected by the UE and means for transmitting, to a wireless entity and based on detection of the security event, information indicative of the occurrence of the security event, the information representative of at least the data collected by the UE that triggered detection of the security event.

A non-transitory computer-readable medium storing code for wireless communications is described. The code may include instructions executable by one or more processors to detect occurrence of a security event that is indicative of an attack against a security vulnerability associated with the UE, where detection of the occurrence of the security event is based on data collected by the UE and transmit, to a wireless entity and based on detection of the security event, information indicative of the occurrence of the security event, the information representative of at least the data collected by the UE that triggered detection of the security event.

Some examples of the method, UEs, and non-transitory computer-readable medium described herein may further include operations, features, means, or instructions for receiving one or more first signals that may be indicative of one or more security events to be reported by the UE, where the data may be collected by the UE based on the one or more first signals.

In some examples of the method, UEs, and non-transitory computer-readable medium described herein, transmitting the information indicative of the occurrence of the security event may include transmitting, to a network entity and based at least in part on receiving the one or more signals, the data collected by the UE, and the method, apparatuses, and non-transitory computer-readable medium may include further operations, features, means, or instructions for receiving one or more control signals from the network entity indicative of occurrence of a security threat based on transmitting the data collected by the UE.

Some examples of the method, UEs, and non-transitory computer-readable medium described herein may further include operations, features, means, or instructions for measuring, based on receiving the one or more first signals, one or more second signals, where the data collected by the UE may be based on measuring the one or more second signals.

In some examples of the method, UEs, and non-transitory computer-readable medium described herein, detecting occurrence of the security event may include operations, features, means, or instructions for detecting a message, a header content, a message sequence, or a delay in accordance with an attack signature database at the UE and detecting a difference in a signal strength, a power level, or both between contiguous signals from a network entity that satisfies a threshold difference, where at least one of the message, the header content, the message sequence, the delay, or the difference in the signal strength, the power level, or both may be associated with the security event.

In some examples of the method, UEs, and non-transitory computer-readable medium described herein, detecting occurrence of the security event may include operations, features, means, or instructions for detecting a message pattern from a second wireless entity that may be different than a previous message pattern form the second wireless entity, where the message pattern includes a message, header content, a message sequence, or a delay.

In some examples of the method, UEs, and non-transitory computer-readable medium described herein, detecting occurrence of the security event may include operations, features, means, or instructions for detecting a measured state of a network entity that may be inconsistent with a measured state of the UE, where the measured state includes a location, a movement, a mobility, or any combination thereof.

In some examples of the method, UEs, and non-transitory computer-readable medium described herein, transmitting, to the wireless entity, the information indicative of the occurrence of the security event may include operations, features, means, or instructions for transmitting the information indirectly to a network entity via a sidelink communications link or via a Wi-Fi communications link, where the wireless entity includes a second UE or a Wi-Fi device and transmitting the information directly to the network entity via an uplink communications link, where the wireless entity includes the network entity.

In some examples of the method, UEs, and non-transitory computer-readable medium described herein, the information indicative of the occurrence of the security event includes a non-access stratum (NAS) or access stratum (AS) security mode control (SMC) failure, a NAS transmission failure, a count value leap, a quantity of NAS retransmissions, a quantity of tracking area code (TAC) changes satisfying a threshold, an integrity check failure log associated with a radio resource control (RRC) layer or a user plane, one or more broadcast messages received at the UE, or any combination thereof.

In some examples of the method, UEs, and non-transitory computer-readable medium described herein, the security event may be detected via an artificial intelligence (AI) model at the UE.

A method for wireless communications by a network entity is described. The method may include receiving information indicative of occurrence of a security event by a UE, the security event indicative of an attack against a security vulnerability associated with the UE, and the information representative of at least data collected by the UE that triggered detection of the security event and performing, based on receiving the information, a security operation corresponding to the security event.

A network entity for wireless communications is described. The network entity may include one or more memories storing processor executable code, and one or more processors coupled with the one or more memories. The one or more processors may individually or collectively be operable to execute the code to cause the network entity to receive information indicative of occurrence of a security event by a UE, the security event indicative of an attack against a security vulnerability associated with the UE, and the information representative of at least data collected by the UE that triggered detection of the security event and perform, based on receiving the information, a security operation corresponding to the security event.

Another network entity for wireless communications is described. The network entity may include means for receiving information indicative of occurrence of a security event by a UE, the security event indicative of an attack against a security vulnerability associated with the UE, and the information representative of at least data collected by the UE that triggered detection of the security event and means for performing, based on receiving the information, a security operation corresponding to the security event.

A non-transitory computer-readable medium storing code for wireless communications is described. The code may include instructions executable by one or more processors to receive information indicative of occurrence of a security event by a UE, the security event indicative of an attack against a security vulnerability associated with the UE, and the information representative of at least data collected by the UE that triggered detection of the security event and perform, based on receiving the information, a security operation corresponding to the security event.

Some examples of the method, network entities, and non-transitory computer-readable medium described herein may further include operations, features, means, or instructions for transmitting one or more signals that may be indicative of one or more security events to be reported by the UE, where receiving the information indicative of the detection of the security event may be based on transmitting the one or more signals.

In some examples of the method, network entities, and non-transitory computer-readable medium described herein, receiving the information indicative of the security event may include receiving, from the UE and based at least in part on transmitting the one or more signals, the data collected by the UE, and the method, apparatuses, and non-transitory computer-readable medium may include further operations, features, means, or instructions for detecting occurrence of a security threat that may be indicative of the attack against the security vulnerability associated with the UE, where detection of the occurrence of the security threat may be based on receiving the data collected by the UE and transmitting one or more control signals to the UE indicative of the occurrence of the security threat based on detecting the occurrence of the security threat.

In some examples of the method, network entities, and non-transitory computer-readable medium described herein, receiving, from the UE, the information indicative of the security event may include operations, features, means, or instructions for receiving the information indirectly from the UE via a sidelink communications link from a second UE or via a Wi-Fi communications link from a Wi-Fi device and receiving the information directly from the UE via an uplink communications link.

In some examples of the method, network entities, and non-transitory computer-readable medium described herein, the information indicative of the occurrence of the security event includes a NAS or AS SMC failure, a NAS transmission failure, a count value leap, a quantity of NAS retransmissions, a quantity of TAC changes satisfying a threshold, an integrity check failure log associated with an RRC layer or a user plane, one or more broadcast messages received at the UE, or any combination thereof.

Some examples of the method, network entities, and non-transitory computer-readable medium described herein may further include operations, features, means, or instructions for identifying a security attack based on receiving the information indicative of occurrence of a security event by the UE and second information indicative of occurrences of the security event by one or more second UEs, where performing the security operation may be based on identifying the security attack, and where the security operation may be associated with the UE and the one or more second UEs.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows an example of a wireless communications system that supports techniques for security event reporting in accordance with one or more aspects of the present disclosure.

FIG. 2 shows an example of a network architecture that supports techniques for security event reporting in accordance with one or more aspects of the present disclosure.

FIG. 3 shows an example of a wireless communications system that supports techniques for security event reporting in accordance with one or more aspects of the present disclosure.

FIG. 4 shows an example of a process flow that supports techniques for security event reporting in accordance with one or more aspects of the present disclosure.

FIGS. 5 and 6 show block diagrams of devices that support techniques for security event reporting in accordance with one or more aspects of the present disclosure.

FIG. 7 shows a block diagram of a communications manager that supports techniques for security event reporting in accordance with one or more aspects of the present disclosure.

FIG. 8 shows a diagram of a system including a device that supports techniques for security event reporting in accordance with one or more aspects of the present disclosure.

FIGS. 9 and 10 show block diagrams of devices that support techniques for security event reporting in accordance with one or more aspects of the present disclosure.

FIG. 11 shows a block diagram of a communications manager that supports techniques for security event reporting in accordance with one or more aspects of the present disclosure.

FIG. 12 shows a diagram of a system including a device that supports techniques for security event reporting in accordance with one or more aspects of the present disclosure.

FIGS. 13 through 16 show flowcharts illustrating methods that support techniques for security event reporting in accordance with one or more aspects of the present disclosure.

### DETAILED DESCRIPTION

Some wireless communications devices may perform attack detection based on features, capabilities, or both of the device. For example, some wireless communications devices may have capabilities to detect security attacks and perform protective corresponding operations, such as perform security operations. However, wireless communications devices may not support signaling to report detection of security attacks. That is, wireless communications systems may not support or include a procedure for security attack detection, security attack reporting, security attack deterrence, or any combination thereof. Lack of reporting for security attacks may be associated with low levels of detection, tracing, or both of a source of the security attack. For example, multiple wireless communications devices may detect a security attack but have limited information about a source of the attack. The source of the attack may not be identified by combining the information obtained by the multiple devices, as reporting of the security event may not be supported. Additionally, data collection performed by wireless communications devices, in some cases, may be associated with managing a performance level rather than detecting security attacks. In such cases, security events may occur in wireless communications systems without detection, reporting, or both as wireless communications devices may not be configured to measure parameters or monitor for conditions indicative of the security events.

As described herein, wireless communication devices in wireless communications system may support security event detection and reporting. A user equipment (UE) may detect occurrence of a security event that is indicative of an attack against a security vulnerability associated with the UE. The detection of the occurrence of the security event may be based on data collected by the UE. That is, the UE may measure security-related data such that security events may be identified. In some examples, the UE may receive one or more signals, such as from a network entity, indicating one or more parameters, security events, or both to be measured or monitored for, respectively, by the UE. That is, the UE may detect occurrence of the security event based on receiving signaling indicating security events to be monitored, security-related data to be collected, or both. The UE may transmit, to a wireless entity and based on the detection of the security event, information indicative of the occurrence of the security event, the information representative of at least the data collected by the UE that triggered detection of the security event. For example, based on the security event detected, the UE may transmit the information directly to the network entity or indirectly to the network entity via another wireless communications device. The network entity may receive the information indicative of the security event and perform a security operation corresponding to the security event. The network entity may receive information from the UE and one or more additional UEs and, in some examples, may identify security threats. The network entity may notify associated UEs of the security threats, perform security operations corresponding to the security threats, or both.

Aspects of the disclosure are initially described in the context of wireless communications systems. Aspects of the disclosure are also described in the context of a network architecture diagram and a process flow. Aspects of the disclosure are further illustrated by and described with reference to apparatus diagrams, system diagrams, and flowcharts that relate to techniques for security event reporting.

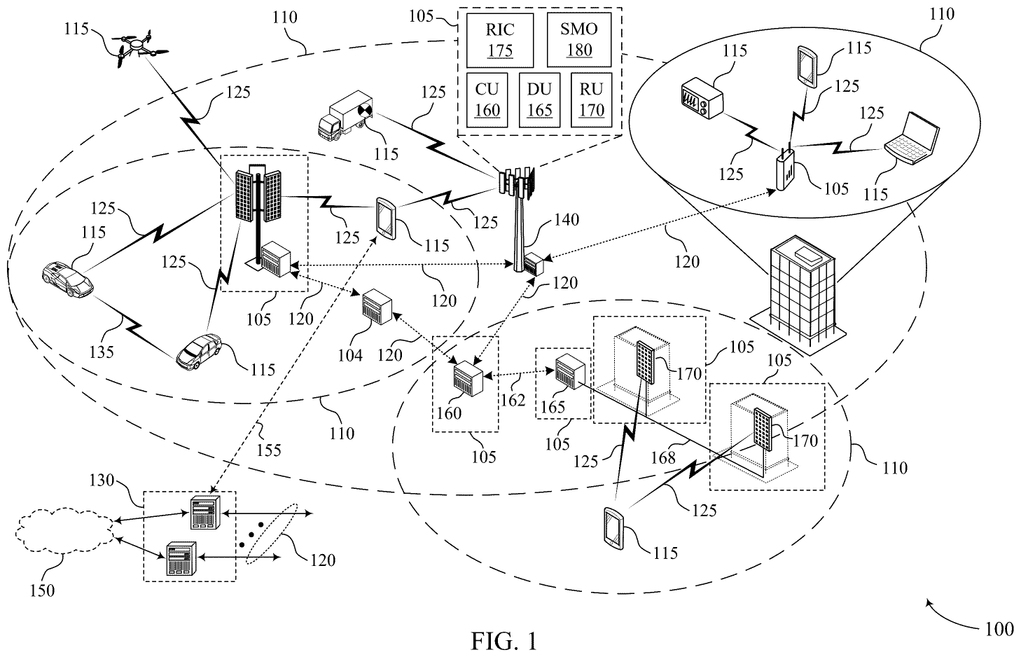

FIG. 1 shows an example of a wireless communications system 100 that supports techniques for security event reporting in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support data collection at one or more wireless communication devices. For example, the core network 130 may perform core network data collection via one or more core network functions, including a NetWork Data Analytics Function (NWDAF). The core network 130 may store data at an Analytics Data Repository Function (ADRF). Additionally, or alternatively, a RAN node may perform RAN data collection via one or more procedures, such as Self Organizing Network (SON), Minimization of Drive Testing (MDT), Quality of Experience (QoE), or the like. The RAN node may store collected data at a Trace Collection Entity (TCE) or a QoE Metrics Collection Entity (MCE). The UE 115 may perform data collection via the one or more procedures, such as the SON, MDT, QoE, or the like. The UE 115 may report the collected data (e.g., rather than storing, as storage may be limited at the UE 115). In some examples, the core network 130, the RAN node, or both may perform one or more functions based on data collected by the UE 115. For example, the core network 130, the RAN node, or both may store data received from the UE 115 and perform one or more operations based on the stored data. The UE 115 may report data to the core network 130, the RAN node, or both based on a configuration, such as based on an RRC configuration.

The UE 115 may collect and report (e.g., based on receiving one or more control signals, including RRC messages) data for one or more operations, including mobility robust optimization (MRO); mobility history report (MHR) (e.g., for a primary cell of a primary cell group (PCell) or a secondary cell group (PSCell)); random access channel (RACH) procedures (e.g., 4-step and 2-step RACH); connection establishment failure (CEF); logged MDT; intermediate MDT; mobility load balancing (MLB); coverage and capacity optimization (CCO); intra-system energy savings; dual active protocol stack (DAPS); conditional handover (CHO); PSCell change; successful handover report (SHR); on-demand system information (SI), uplink/downlink coverage imbalance; logged MDT enhancements; inter-system energy savings; MRO for conditional PSCell addition and change (CPAC); MRO for voice fallback; MRO for fast master cell group recovery; SHR for inter-radio access technology (RAT) handover; successful PSCell change report (SPR); RACH partitioning; Msg3 repetitions; inter-RAT logged MDT override protection; SON/MDT for non-public networks (NPNs); SON/MDT for New Ratio-Unlicensed (NR-U); MRO for low-layer triggered mobility (LTM) and coexistence scenarios; SON/MDT for non-terrestrial networks, slicing, multicast and broadcast services (MBS), IAB, small data transmission (SDT), sidelink, unmanned aerial vehicle (UAV), Msg-1 repetitions; or any combination thereof.

One or more wireless communication devices in the wireless communications system 100 may support security event detection and reporting. For example, the UE 115 may detect occurrence of a security event that is indicative of an attack against a security vulnerability associated with the UE 115. The detection of the occurrence of the security event may be based on data collected by the UE 115 and, in some examples, based on an indication of security events to be reported by the UE 115 (e.g., received prior to the detection). The UE 115 may transmit, to a wireless entity and based on the detection of the security event, information indicative of the occurrence of the security event, the information representative of at least the data collected by the UE 115 that triggered detection of the security event. For example, the UE 115 may transmit the information directly to the network entity 105, such as via an uplink communications link, or indirectly via another wireless communications device, such as to the network entity 105 via another UE 115 via a sidelink communications link. The network entity 105 may receive the information indicative of the security event and perform a security operation corresponding to the security event.

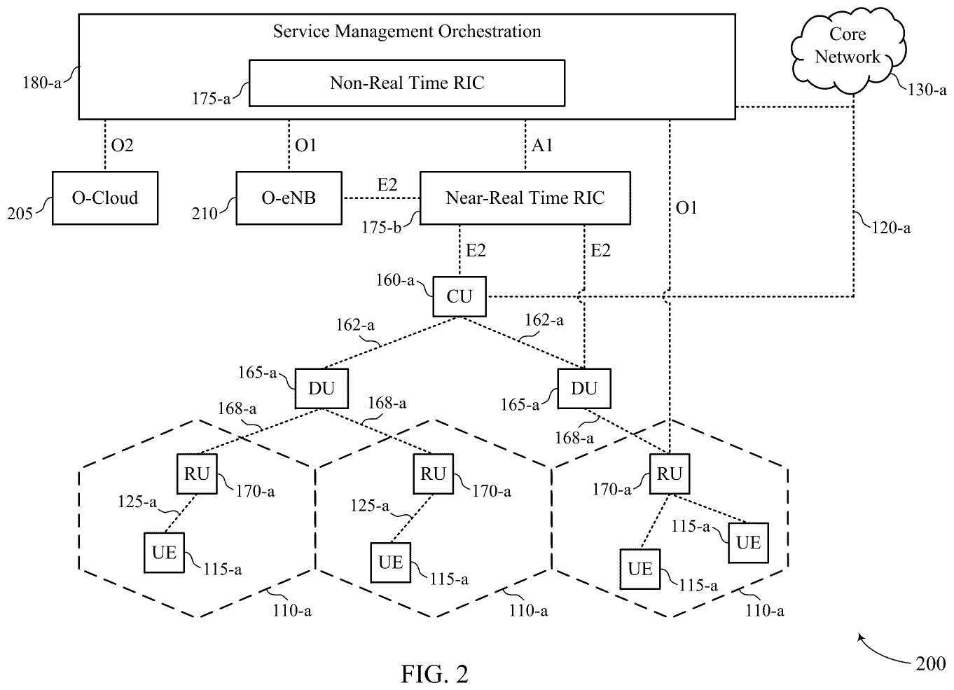

FIG. 2 shows an example of a network architecture 200 (e.g., a disaggregated base station architecture, a disaggregated RAN architecture) that supports techniques for security event reporting in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

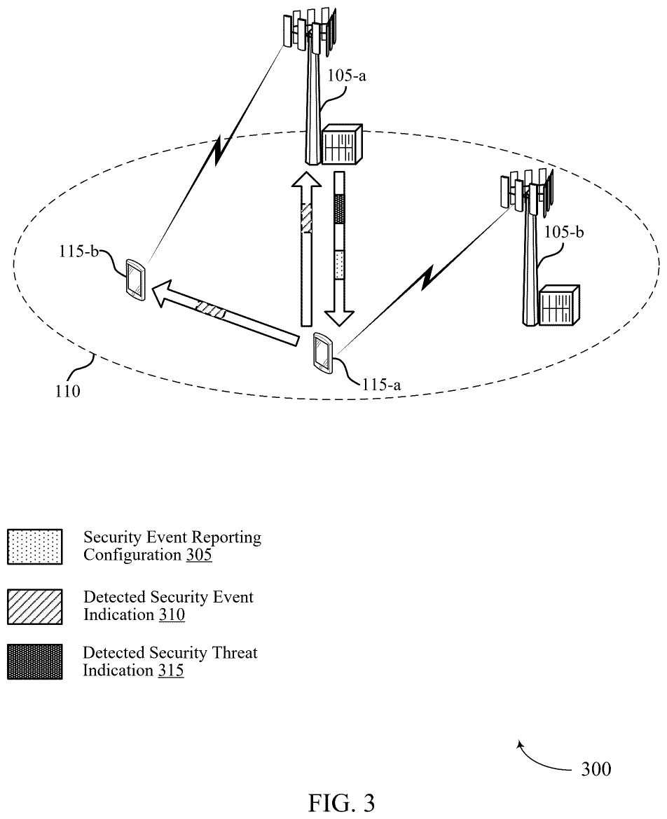

FIG. 3 shows an example of a wireless communications system 300 that supports techniques for security event reporting in accordance with one or more aspects of the present disclosure. The wireless communications system 300 may implement or be implemented by various aspects of the wireless communications system 100, the network architecture 200, or both. For example, the wireless communications system 300 may include a network entity 105-a, a network entity 105-b, a coverage area 110, a UE 115-a, and a UE 115-b, which may represent examples of corresponding devices as described with reference to FIGS. 1 and 2.

One or more of the wireless communications devices in the wireless communications system 300 may include capabilities or features to identify security events. For example, the network entity 105-a, the UE 115-a, the UE 115-b, or any combination thereof may have capabilities to identify security events or security threats. In some examples, the network entity 105-a, the UE 115-a, the UE 115-b, or any combination thereof may identify security events or security attacks via an AI model, an ML model, or both. In other words, the wireless communications devices as described with reference to FIG. 2 may include on-device features, such as AI or ML models, to identify security events or threats.

As used herein, security events may refer to triggering events at UEs, such as the UE 115-a, the UE 115-b, or both that, when detected, are reported to a network entity, such as the network entity 105-a. In other words, a security event may refer to one or more security-related conditions being detected or satisfied at a UE such that transmission of a report by the UE towards a network entity indicating detection of such conditions is triggered. Additionally, as used herein, security threats may refer to security-related conditions at a network entity, such as the network entity 105-a. In other words, security threats may refer to security-related conditions detected by a network entity. Security threats may, in some examples, be indicated to UEs associated with the network entity, such as the UE 115-a and the UE 115-b associated with the network entity 105-a. Additionally, or alternatively, the network entity may perform security operations corresponding to the security threat (e.g., without explicitly notifying associated UEs of the security threat).

The network entity 105-a may provide configuration information associated with security event reporting to the UE 115-a. That is, the network entity 105-a may output a security event reporting configuration 305 to the UE 115-a. While not shown in the example of FIG. 3, the network entity 105-a may transmit the security event reporting configuration 305 (e.g., a same configuration or different configurations) to additional UEs, including the UE 115-b. The security event reporting configuration 305 may include information indicative of one or more security events to be reported by the UE 115-a. For example, the security event reporting configuration 305 may include security-related conditions that, when detected by the UE 115-a, are to be reported as a security event. That is, the security event reporting configuration 305 may include a first set of conditions associated with a first security event, a second set of conditions associated with a second security event, and so on. One such example of a security event may be a fake base station, including an in-coverage fake base station, a man-in-the-middle fake base station, a signal overshadowing fake base station, or the like. The security reporting configuration may include information about the network entity to which the security event is reported (e.g., the network entity 105-a). Such information may include an IP address, network entity identity, service identifier, or any combination thereof.

The UE 115-a may detect security events based on the security event reporting configuration 305. To detect the security events, the UE 115-a may monitor for conditions associated with the one or more security events included in the security event reporting configuration 305. Monitoring for the conditions may include performing measurements, collecting data, or both. That is, the UE 115-a may measure parameters of incoming signals and store the measurements (e.g., collect data). The UE 115-a may detect a security event based on the measurements. The UE 115-a may detect the security event based on collected data, where the collected data is indicative of the security event. For example, the collected data may indicate or satisfy a set of conditions associated with the security event.

In some examples, the UE 115-a may detect the security event based on signature-based detection. Signature-based detection may include detection of an attack pattern (e.g., a known attack pattern), which may include a message or header content (e.g., abnormal or unexpected message or header content), a message sequence, or a delay. In some examples, the signature-based detection may be based on a signature database, an ML classifier, or both at the UE 115-a. That is, the UE 115-a may access the signature database to determine whether collected data is indicative of a security event, where the signature database includes multiple attack patterns corresponding to different security events. Additionally, or alternatively, the UE 115-a may input the collected data into the ML classifier, where the ML classifier is configured to identify whether the collected data is indicative of a security event and classify the detected security event.

The UE 115-a may detect the security event based on behavioral detection. Behavioral detection may include detection of abrupt signal strength changes, a higher power signal, a forced downgrade of a RAT, an inconsistency or mismatch between one or more measured states, or any combination thereof. For example, the UE 115-a may detect the security event based on a first signal received from the network entity 105-b having a first signal strength or power and a second signal received from the network entity 105-b having a second signal strength or power, where a difference between the first signal strength or power and the second signal strength or power satisfies a threshold signal strength or power associated with security event detection. Additionally, or alternatively, the UE 115-a may detect the security event based on the network entity 105-b communicating with the UE 115-a via a different RAT than previously used at the UE 115-a. The UE 115-a may also, in some examples, detect the security event based on an inconsistency between measured states of the UE 115-a, the network entity 105, or both. For example, the UE 115-a may detect the security event based on the UE 115-a moving relatively fast with no change of a serving cell or based on the UE 115-a being stationary with relatively frequent changes to the serving cell. The UE 115-a may detect such measured states via one or more sensing or location technologies, such as via Wi-Fi, a gyroscope, or the like.

The UE 115-a may report the security event to the network entity 105-a based on the detection. In some examples, the UE 115-a may report the security event to the network entity 105-a directly. That is, the UE 115-a may transmit a detected security event indication to the network entity 105-a via an uplink communications link. In some examples, the UE 115-a may report the security event to a function or component of the network entity 105-a (e.g., a central service) or a different network entity (e.g., a non-collocated network entity). Alternatively, the UE 115-a may report the security event to the network entity 105-a indirectly. For example, the UE 115-a may transmit the detected security event indication 310 to the UE 115-b, such as via a sidelink communications link, a Wi-Fi communications link, or the like. The UE 115-b may relay the detected security event indication 310 to the network entity 105-a on behalf of the UE 115-a. Additionally, or alternatively, the UE 115-a may report the security event to a base station, such as the base station 140 as described with reference to FIG. 1. For example, the UE 115-a may report the security event to the network entity 105-a indirectly via the base station, where the base station is collocated or non-collocated with the network entity 105-a (e.g., a security event server). In such examples, the network entity 105-a may notify the base station of security events, security threats, or both.

The UE 115-a may transmit the detected security event indication 310 directly or indirectly based on a type of security event detected. For example, in examples in which the UE 115-a detects a security event related to a communications link with the network entity 105-a, the UE 115-a may transmit the detected security event indication 310 indirectly. In other words, if a communications link between the UE 115-a and the network entity 105-a is subject to a security event (e.g., is unsecure), the UE 115-a may transmit the detected security event indication 310 indirectly.

The detected security event indication 310 may identify the detected security event and the collected data indicative of the security event. For example, the detected security event indication 310 may include data associated with detection of the security event. The detected security event indication 310 may include the collected data such that the network entity 105-a may attempt to identify a source of the security attack. In other words, the network entity 105-a may identify a source of the security event based on the collected data included in the detected security event indication 310.

Additionally, or alternatively, the detected security event indication 310 may include an indication of a non-access stratum (NAS) or access stratum (AS) security mode control (SMC) failure, a NAS transmission failure, a count value leap, a quantity of NAS retransmissions, a quantity of tracking area code (TAC) changes satisfying a threshold (e.g., frequent TAC changes), an integrity check failure log associated with a RRC layer or a user plane, one or more broadcast messages (e.g., master information block (MIB), system information block (SIB), public warning system (PWS), commercial mobile alert system (CMAS), or earthquake and tsunami warning system (ETWS) messages) received at the UE 115-a, or any combination thereof.

The network entity 105-a may identify one or more features of the security event based on the detected security event indication 310. For example, the network entity 105-a may identify an attack pattern of the security event, including a frequency, duration, location (e.g., based on triangulation), mobility (e.g., stationary or mobile), or the like. Based on receiving the detected security event indication 310, the network entity 105-a may perform a security operation. For example, the network entity 105-a may transmit control signaling to the UE 115-a based on receiving the detected security event indication 310. As an example, the control signaling may indicate for the UE 115-a to select a new cell.

The network entity 105-a may, in addition to or alternatively from the UE 115-a, perform security event detection. Security event detection at the network entity 105-a may be referred to herein as security threat detection. The network entity 105-a may perform security threat detection via signature-based detection, behavioral detection, and one or more other detection procedures described with reference to security event detection at the UE 115-a. The network entity 105-a may indicate a detected security threat to one or more UEs, such as the UE 115-a and the UE 115-b. For example, the network entity 105-a may transmit a detected security threat indication 315 to the UE 115-a.

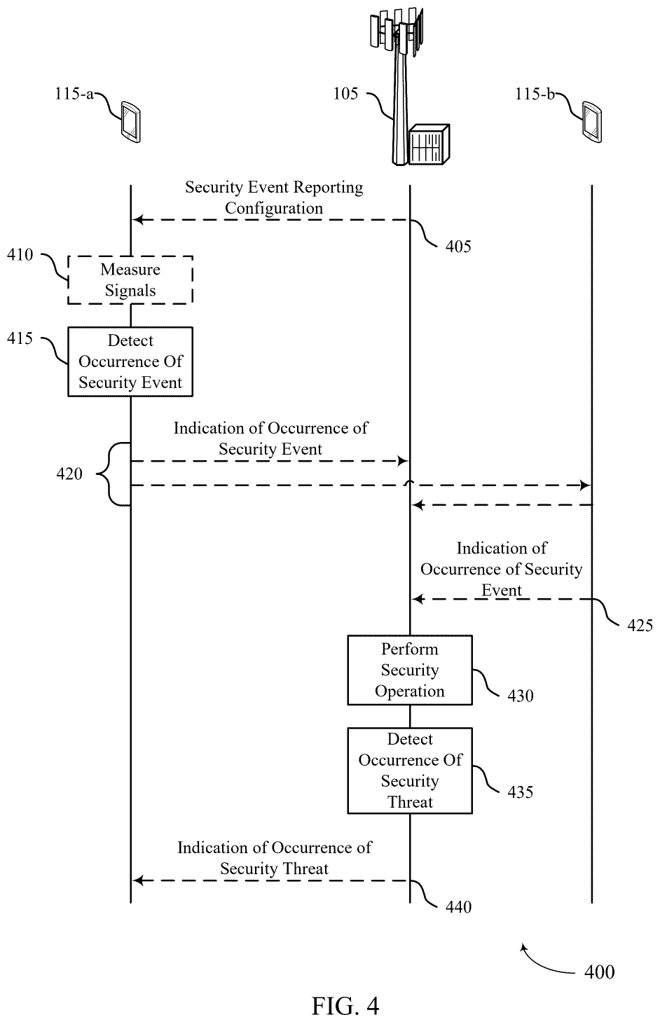

FIG. 4 shows an example of a process flow 400 that supports techniques for security event reporting in accordance with one or more aspects of the present disclosure. The process flow 400 may implement or be implemented by aspects of the wireless communications system 100, the network architecture 200, the wireless communications system 300, or any combination thereof as described with reference to FIGS. 1 through 3. For example, the process flow 400 may include a network entity 105, a UE 115-a, and a UE 115-b, which may be examples of corresponding devices as described with reference to FIGS. 1 and 3.

Alternative examples of the following may be implemented, where some operations are performed in a different order than described or are not performed at all. In some cases, operations may include additional features not mentioned below, or further operations may be added. Although the network entity 105, the UE 115-a, and the UE 115-b are shown performing the operations of the process flow 400, some aspects of some operations may also be performed by one or more other wireless devices.

At 405, the network entity 105 may output a security event reporting configuration to the UE 115-a. For example, the UE 115-a may receive one or more first signals that are indicative of one or more security events to be reported by the UE 115-a. The one or more first signals may include the security event reporting configuration, which may be an example of the security event reporting configuration 305 as described with reference to FIG. 3. In some examples, the network entity 105 may output the security event reporting configuration via RRC signaling.

At 410, the UE 115-a may measure signals. For example, the UE 115-a may measure, based on receiving the one or more first signals at 405, one or more second signals. In some examples, the one or more second signals may be from a network entity, such as the network entity 105-b as described with reference to FIG. 3. The UE 115-a may collect data based on the one or more first signals at 405, the one or more second signals at 410, or both.

At 415, the UE 115-a may detect an occurrence of a security event. For example, the UE 115-a may detect occurrence of a security event that is indicative of an attack against a security vulnerability associated with the UE 115-a, where detection of the occurrence of the security event is based at least in part on data collected by the UE 115-a. That is, the UE 115-a may identify one or more parameters in the data collected based on the signals at 415, where the identified parameters correspond to the security event. The security event may be one of the one or more security events to be reported by the UE 115-a according to the configuration received at 405. In some examples, the security event may be detected via an AI model at the UE 115-a.

Detecting the occurrence of the security event may include detecting a message, a header content, a message sequence, or a delay in accordance with an attack signature database at the UE or detecting a difference in a signal strength, a power level, or both between contiguous signals from a network entity (e.g., the network entity 105-b, as described with reference to FIG. 3) that satisfies a threshold difference. In other words, the UE 115-a may detect the security event based on signature-based detection or behavioral-based detection. In such examples, at least one of the message, the header content, the message sequence, the delay, or the difference in the signal strength, the power level, or both may be associated with the security event.

Additionally, or alternatively, detecting the occurrence of the security event may include detecting a message pattern from a second wireless entity that is different than a previous message pattern form the second wireless entity, where the message pattern comprises a message, header content, a message sequence, or a delay. In other words, the UE 115-a may detect the security event based on deviation from a historical pattern. In some examples, detecting the occurrence of the security event may include detecting a measured state of a network entity that is inconsistent with a measured state of the UE 115-a, where the measured state includes a location, a movement, a mobility, or any combination thereof.

At 420, the UE 115-a may transmit an indication of the occurrence of the security event. For example, the UE 115-a may transmit, based on detection of the security event, information indicative of the occurrence of the security event. The information may be representative of at least the data collected by the UE 115-a that triggered detection of the security event at 415. Additionally, or alternatively, the information indicative of the occurrence of the security event may include a NAS or AS SMC failure, a NAS transmission failure, a count value leap, a quantity of NAS retransmissions, a quantity of TAC changes satisfying a threshold, an integrity check failure log associated with a RRC layer or a user plane, one or more broadcast messages received at the UE 115-a, or any combination thereof. The indication of the occurrence of the security event may be an example of the detected security event indication 310 as described with reference to FIG. 3.

The UE 115-a may transmit the indication to the network entity 105 directly or indirectly. That is, the UE 115-a may transmit the indication to a wireless entity, where the wireless entity may be a network entity 105 (e.g., for direct indication), a base station (e.g., for indirect indication), or a UE 115-b (e.g., for indirect indication). For example, the UE 115-a may transmit the information indicative of the occurrence of the security event indirectly to the network entity 105 via a sidelink communications link or via a Wi-Fi communications link, wherein the wireless entity may be the UE 115-a (e.g., a second UE or a Wi-Fi device). In another example, the UE 115-a may transmit the information indicative of the occurrence of the security event indirectly to the network entity 105 via an uplink communications link with a base station, such as the base station 140 as described with reference to FIG. 1. The base station may be collocated or non-collocated with the network entity 105-a. Alternatively, the UE 115-a may transmit the information indicative of the occurrence of the security event directly to the network entity 105 via an uplink communications link, where the wireless entity may be the network entity 105. The network entity 105-a may be an example of or referred to as a security event server.

At 425, the UE 115-b may transmit an indication of an occurrence of the security event to the network entity 105. For example, the UE 115-a may perform measurements, detect the occurrence of the security event, and report the detection to the network entity 105 (e.g., directly or indirectly).

At 430, the network entity 105 may perform a security operation. For example, the network entity 105 may perform, based on receiving the information at 420, a security operation corresponding to the security event. In some examples, the network entity 105 may perform the security operation based on receiving the indication of the occurrence of the security event from multiple UEs. That is, the network entity 105 may identify a security threat (e.g., corresponding to a combination of the indicated security events) attack based on receiving the information indicative of occurrence of a security event by the UE 115-a and second information indicative of occurrences of the security event by one or more second UEs (e.g., including the UE 115-b), where performing the security operation at 430 is based on identifying the security threat, and where the security operation is associated with the UE 115-a and the one or more second UEs (e.g., including the UE 115-b). In some examples, the UE 115-a may report a location of the UE, a strength of the attack signal, a measured distance from the attacker, or any combination thereof. The network entity 105 may identify the location of an attacker based on the information reported by multiple UEs, including the UE 115-a and the UE 115-b. In some examples, the location may have an accuracy level based on the information being provided by a threshold quantity of UEs, such as three UEs.

At 435, the network entity 105 may detect an occurrence of a security threat. For example, the network entity 105 may detect an occurrence of a security threat that is indicative of the attack against the security vulnerability associated with the UE 115-a. In some examples, the network entity 105 may detect the security threat based b on receiving the data collected by the UE 115-a (e.g., at 410). That is, the network entity 105 may receive, via the indication of the occurrence of the security event at 420 or via a separate message, the data collected by the UE 115-a.

At 440, the network entity 105 may output an indication of an occurrence of a security threat to the UE 115-a. For example, the network entity 105 may transmit one or more control signals to the UE 115 indicative of the occurrence of the security threat based on detecting the occurrence of the security threat at 435. The indication of the occurrence of the security threat may be an example of the detected security threat indication 315 as described with reference to FIG. 3. The network entity 105 may change the configuration based on the detection of security threat. In some examples, the network entity 105 may output the indication of the occurrence of the security threat and/or change the configuration such that the UE 115-a may perform a security operation (e.g., a UE-side action, such as avoiding an identified cell, a RAT type, etc.).

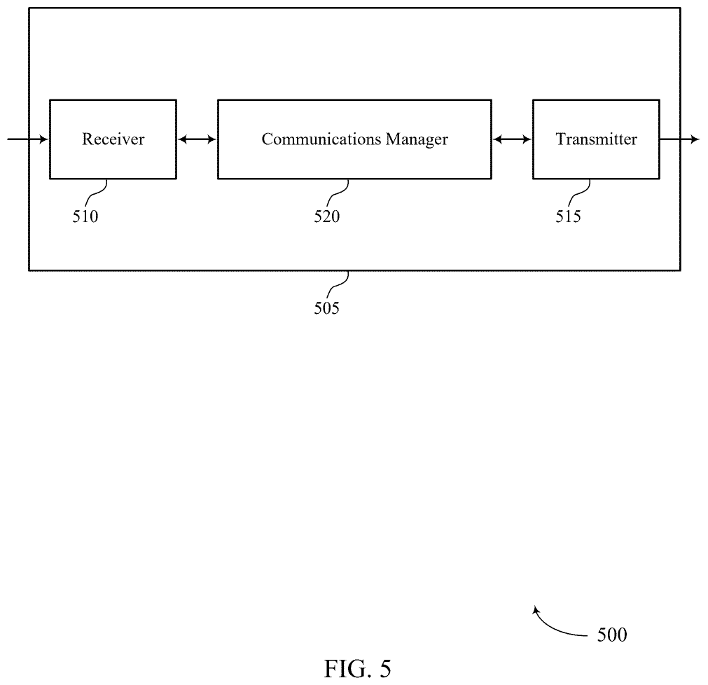

FIG. 5 shows a block diagram 500 of a device 505 that supports techniques for security event reporting in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for security event reporting). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for security event reporting). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for security event reporting as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for detecting occurrence of a security event that is indicative of an attack against a security vulnerability associated with the UE, where detection of the occurrence of the security event is based on data collected by the UE. The communications manager 520 is capable of, configured to, or operable to support a means for transmitting, to a wireless entity and based on detection of the security event, information indicative of the occurrence of the security event, the information representative of at least the data collected by the UE that triggered detection of the security event.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for improved security related to security event detection and reporting.

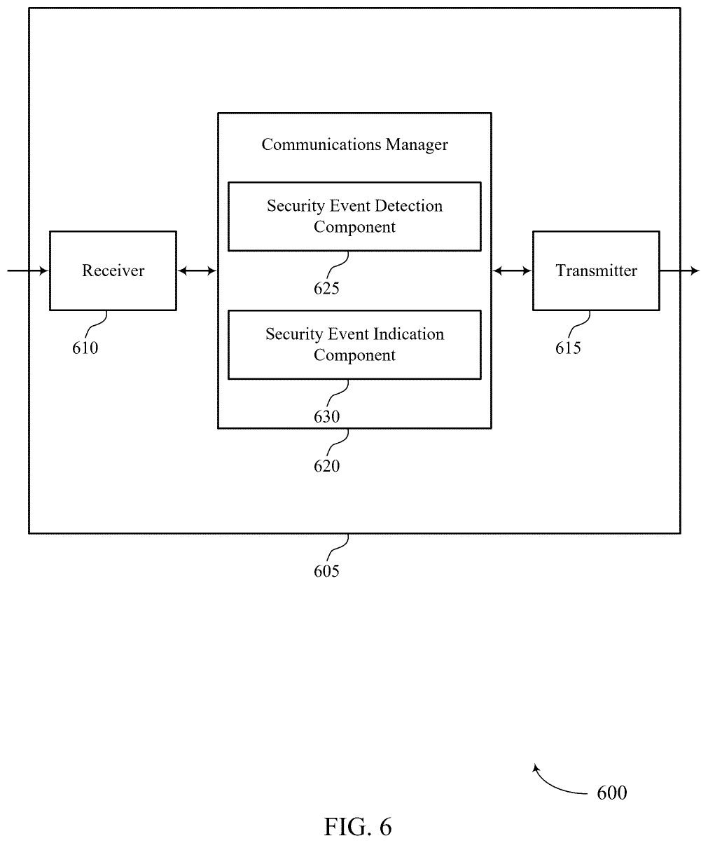

FIG. 6 shows a block diagram 600 of a device 605 that supports techniques for security event reporting in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for security event reporting). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for security event reporting). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for security event reporting as described herein. For example, the communications manager 620 may include a security event detection component 625 a security event indication component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The security event detection component 625 is capable of, configured to, or operable to support a means for detecting occurrence of a security event that is indicative of an attack against a security vulnerability associated with the UE, where detection of the occurrence of the security event is based on data collected by the UE. The security event indication component 630 is capable of, configured to, or operable to support a means for transmitting, to a wireless entity and based on detection of the security event, information indicative of the occurrence of the security event, the information representative of at least the data collected by the UE that triggered detection of the security event.

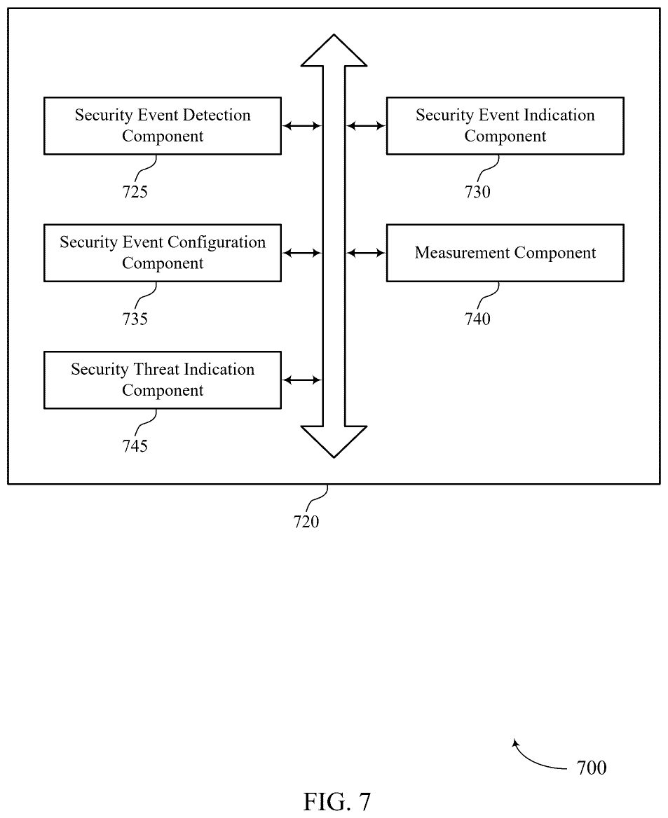

FIG. 7 shows a block diagram 700 of a communications manager 720 that supports techniques for security event reporting in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for security event reporting as described herein. For example, the communications manager 720 may include a security event detection component 725, a security event indication component 730, a security event configuration component 735, a measurement component 740, a security threat indication component 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The security event detection component 725 is capable of, configured to, or operable to support a means for detecting occurrence of a security event that is indicative of an attack against a security vulnerability associated with the UE, where detection of the occurrence of the security event is based on data collected by the UE. The security event indication component 730 is capable of, configured to, or operable to support a means for transmitting, to a wireless entity and based on detection of the security event, information indicative of the occurrence of the security event, the information representative of at least the data collected by the UE that triggered detection of the security event.

In some examples, the security event configuration component 735 is capable of, configured to, or operable to support a means for receiving one or more first signals that are indicative of one or more security events to be reported by the UE, where the data is collected by the UE based on the one or more first signals.

In some examples, transmitting the information indicative of the occurrence of the security event may include transmitting, to a network entity and based on receiving the one or more signals, the data collected by the UE, and the security threat indication component 745 is capable of, configured to, or operable to support a means for receiving one or more control signals from the network entity indicative of occurrence of a security threat based on transmitting the data collected by the UE.

In some examples, the measurement component 740 is capable of, configured to, or operable to support a means for measuring, based on receiving the one or more first signals, one or more second signals, where the data collected by the UE is based on measuring the one or more second signals.

In some examples, to support detecting occurrence of the security event, the security event detection component 725 is capable of, configured to, or operable to support a means for detecting a message, a header content, a message sequence, or a delay in accordance with an attack signature database at the UE. In some examples, to support detecting occurrence of the security event, the security event detection component 725 is capable of, configured to, or operable to support a means for detecting a difference in a signal strength, a power level, or both between contiguous signals from a network entity that satisfies a threshold difference, where at least one of the message, the header content, the message sequence, the delay, or the difference in the signal strength, the power level, or both is associated with the security event.

In some examples, to support detecting occurrence of the security event, the security event detection component 725 is capable of, configured to, or operable to support a means for detecting a message pattern from a second wireless entity that is different than a previous message pattern form the second wireless entity, where the message pattern includes a message, header content, a message sequence, or a delay.

In some examples, to support detecting occurrence of the security event, the security event detection component 725 is capable of, configured to, or operable to support a means for detecting a measured state of a network entity that is inconsistent with a measured state of the UE, where the measured state includes a location, a movement, a mobility, or any combination thereof.

In some examples, to support transmitting, to the wireless entity, the information indicative of the occurrence of the security event, the security event indication component 730 is capable of, configured to, or operable to support a means for transmitting the information indirectly to a network entity via a sidelink communications link or via a Wi-Fi communications link, where the wireless entity includes a second UE or a Wi-Fi device. In some examples, to support transmitting, to the wireless entity, the information indicative of the occurrence of the security event, the security event indication component 730 is capable of, configured to, or operable to support a means for transmitting the information directly to the network entity via an uplink communications link, where the wireless entity includes the network entity.

In some examples, the information indicative of the occurrence of the security event includes a NAS or AS SMC failure, a NAS transmission failure, a count value leap, a quantity of NAS retransmissions, a quantity of TAC changes satisfying a threshold, an integrity check failure log associated with an RRC layer or a user plane, one or more broadcast messages received at the UE, or any combination thereof.

In some examples, the security event is detected via an AI model at the UE.

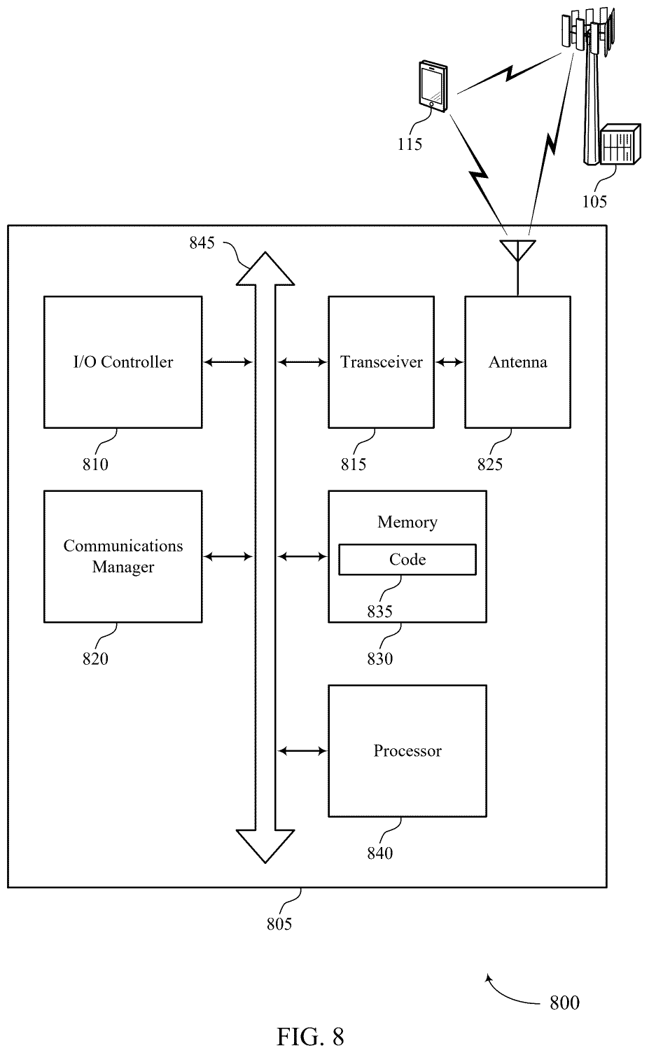

FIG. 8 shows a diagram of a system 800 including a device 805 that supports techniques for security event reporting in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for security event reporting). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for detecting occurrence of a security event that is indicative of an attack against a security vulnerability associated with the UE, where detection of the occurrence of the security event is based on data collected by the UE. The communications manager 820 is capable of, configured to, or operable to support a means for transmitting, to a wireless entity and based on detection of the security event, information indicative of the occurrence of the security event, the information representative of at least the data collected by the UE that triggered detection of the security event.

By including or configuring the communications manager 820 in accordance with examples as described herein, the device 805 may support techniques for improved security related to security event detection and reporting.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for security event reporting as described herein, or the at least one processor 840 and the at least one memory 830 may be otherwise configured to, individually or collectively, perform or support such operations.

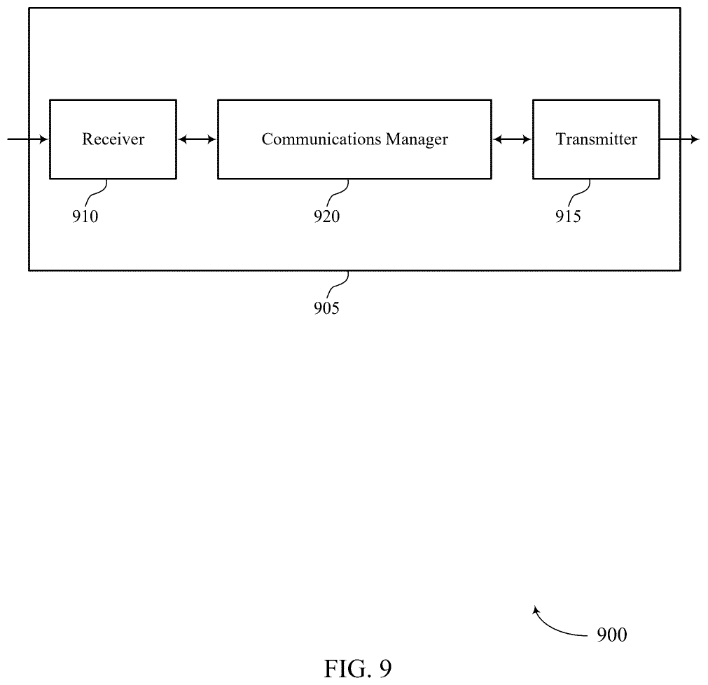

FIG. 9 shows a block diagram 900 of a device 905 that supports techniques for security event reporting in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for security event reporting as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving information indicative of occurrence of a security event by a UE, the security event indicative of an attack against a security vulnerability associated with the UE, and the information representative of at least data collected by the UE that triggered detection of the security event. The communications manager 920 is capable of, configured to, or operable to support a means for performing, based on receiving the information, a security operation corresponding to the security event.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for improved security related to security event detection and reporting.

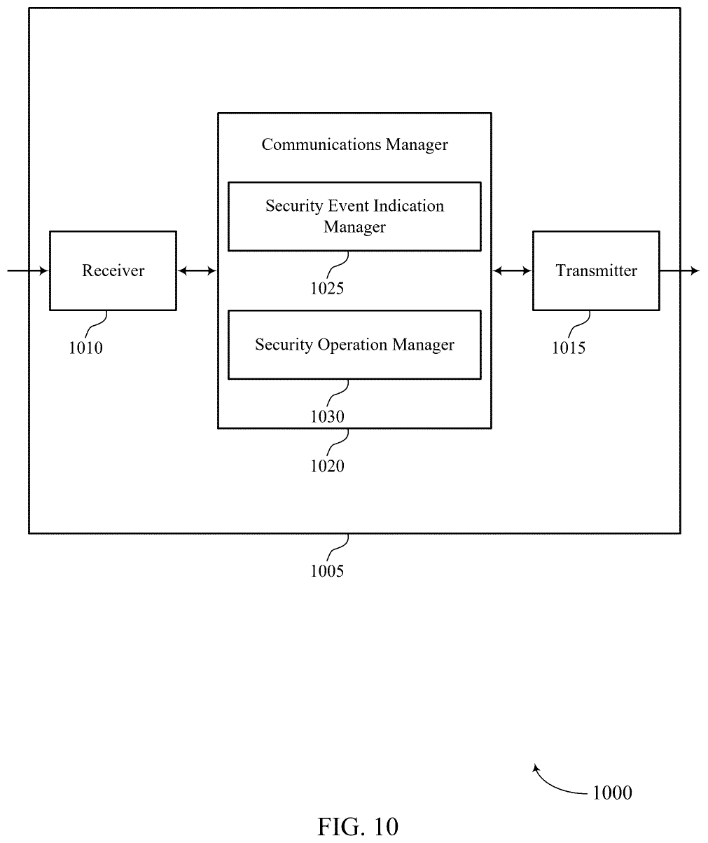

FIG. 10 shows a block diagram 1000 of a device 1005 that supports techniques for security event reporting in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for security event reporting as described herein. For example, the communications manager 1020 may include a security event indication manager 1025 a security operation manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The security event indication manager 1025 is capable of, configured to, or operable to support a means for receiving information indicative of occurrence of a security event by a UE, the security event indicative of an attack against a security vulnerability associated with the UE, and the information representative of at least data collected by the UE that triggered detection of the security event. The security operation manager 1030 is capable of, configured to, or operable to support a means for performing, based on receiving the information, a security operation corresponding to the security event.

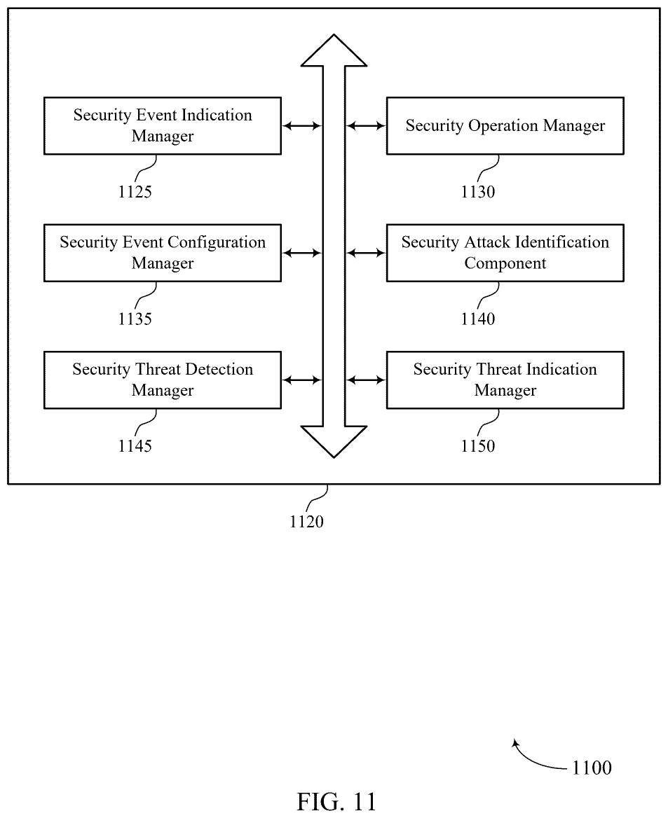

FIG. 11 shows a block diagram 1100 of a communications manager 1120 that supports techniques for security event reporting in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for security event reporting as described herein. For example, the communications manager 1120 may include a security event indication manager 1125, a security operation manager 1130, a security event configuration manager 1135, a security attack identification component 1140, a security threat detection manager 1145, a security threat indication manager 1150, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The security event indication manager 1125 is capable of, configured to, or operable to support a means for receiving information indicative of occurrence of a security event by a UE, the security event indicative of an attack against a security vulnerability associated with the UE, and the information representative of at least data collected by the UE that triggered detection of the security event. The security operation manager 1130 is capable of, configured to, or operable to support a means for performing, based on receiving the information, a security operation corresponding to the security event.

In some examples, the security event configuration manager 1135 is capable of, configured to, or operable to support a means for transmitting one or more signals that are indicative of one or more security events to be reported by the UE, where receiving the information indicative of the detection of the security event is based on transmitting the one or more signals.

In some examples, receiving the information indicative of the security event may include receiving, from the UE and based on transmitting the one or more signals, the data collected by the UE, and the security threat detection manager 1145 is capable of, configured to, or operable to support a means for detecting occurrence of a security threat that is indicative of the attack against the security vulnerability associated with the UE, where detection of the occurrence of the security threat is based on receiving the data collected by the UE. The security threat indication manager 1150 may be capable of, configured to, or operable to support a means for transmitting one or more control signals to the UE indicative of the occurrence of the security threat based on detecting the occurrence of the security threat.

In some examples, to support receiving, from the UE, the information indicative of the security event, the security event indication manager 1125 is capable of, configured to, or operable to support a means for receiving the information indirectly from the UE via a sidelink communications link from a second UE or via a Wi-Fi communications link from a Wi-Fi device. In some examples, to support receiving, from the UE, the information indicative of the security event, the security event indication manager 1125 is capable of, configured to, or operable to support a means for receiving the information directly from the UE via an uplink communications link.

In some examples, the information indicative of the occurrence of the security event includes a NAS or AS SMC failure, a NAS transmission failure, a count value leap, a quantity of NAS retransmissions, a quantity of TAC changes satisfying a threshold, an integrity check failure log associated with an RRC layer or a user plane, one or more broadcast messages received at the UE, or any combination thereof.

In some examples, the security attack identification component 1140 is capable of, configured to, or operable to support a means for identifying a security attack based on receiving the information indicative of occurrence of a security event by the UE and second information indicative of occurrences of the security event by one or more second UEs, where performing the security operation is based on identifying the security attack, and where the security operation is associated with the UE and the one or more second UEs.

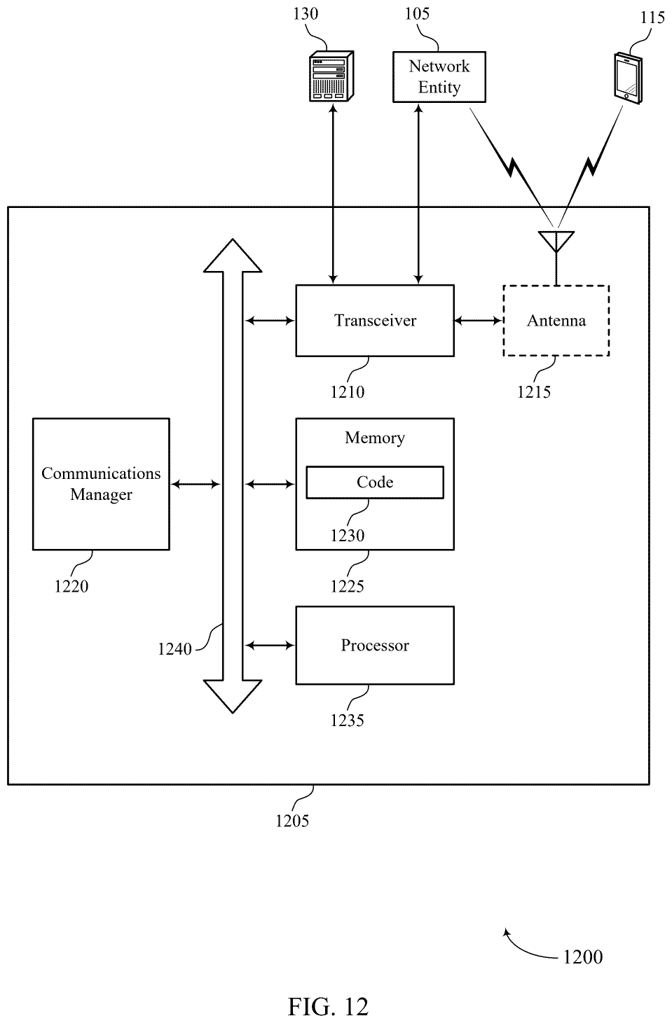

FIG. 12 shows a diagram of a system 1200 including a device 1205 that supports techniques for security event reporting in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for security event reporting). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for receiving information indicative of occurrence of a security event by a UE, the security event indicative of an attack against a security vulnerability associated with the UE, and the information representative of at least data collected by the UE that triggered detection of the security event. The communications manager 1220 is capable of, configured to, or operable to support a means for performing, based on receiving the information, a security operation corresponding to the security event.

By including or configuring the communications manager 1220 in accordance with examples as described herein, the device 1205 may support techniques for improved security related to security event detection and reporting.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for security event reporting as described herein, or the at least one processor 1235 and the at least one memory 1225 may be otherwise configured to, individually or collectively, perform or support such operations.

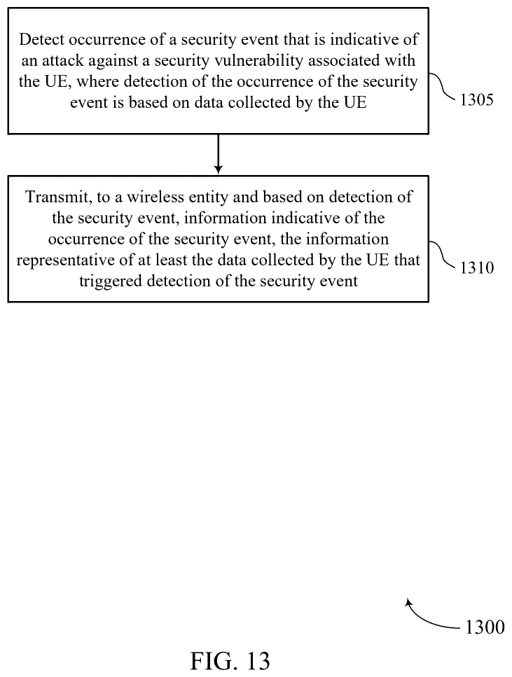

FIG. 13 shows a flowchart illustrating a method 1300 that supports techniques for security event reporting in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include detecting occurrence of a security event that is indicative of an attack against a security vulnerability associated with the UE, where detection of the occurrence of the security event is based on data collected by the UE. The operations of 1305 may be performed in accordance with examples as disclosed herein. In some examples, aspects of the operations of 1305 may be performed by a security event detection component 725 as described with reference to FIG. 7.

At 1310, the method may include transmitting, to a wireless entity and based on detection of the security event, information indicative of the occurrence of the security event, the information representative of at least the data collected by the UE that triggered detection of the security event. The operations of 1310 may be performed in accordance with examples as disclosed herein. In some examples, aspects of the operations of 1310 may be performed by a security event indication component 730 as described with reference to FIG. 7.

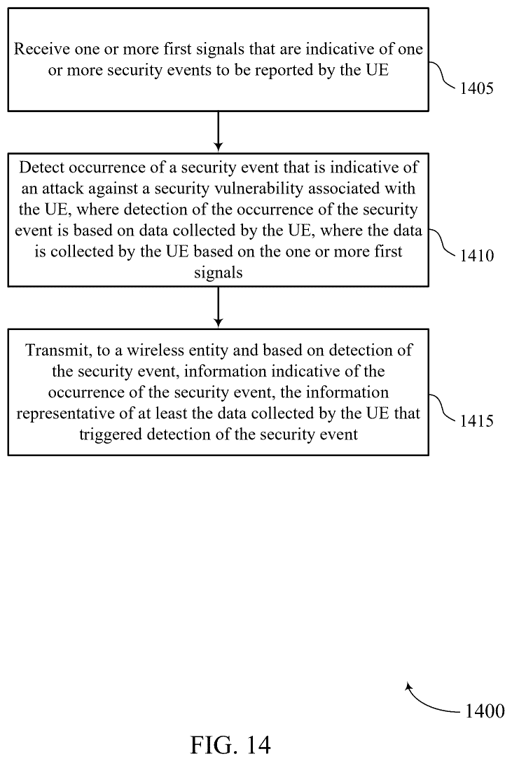

FIG. 14 shows a flowchart illustrating a method 1400 that supports techniques for security event reporting in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving one or more first signals that are indicative of one or more security events to be reported by the UE. The operations of 1405 may be performed in accordance with examples as disclosed herein. In some examples, aspects of the operations of 1405 may be performed by a security event configuration component 735 as described with reference to FIG. 7.

At 1410, the method may include detecting occurrence of a security event that is indicative of an attack against a security vulnerability associated with the UE, where detection of the occurrence of the security event is based on data collected by the UE, where the data is collected by the UE based on the one or more first signals. The operations of 1410 may be performed in accordance with examples as disclosed herein. In some examples, aspects of the operations of 1410 may be performed by a security event detection component 725 as described with reference to FIG. 7.

At 1415, the method may include transmitting, to a wireless entity and based on detection of the security event, information indicative of the occurrence of the security event, the information representative of at least the data collected by the UE that triggered detection of the security event. The operations of 1415 may be performed in accordance with examples as disclosed herein. In some examples, aspects of the operations of 1415 may be performed by a security event indication component 730 as described with reference to FIG. 7.

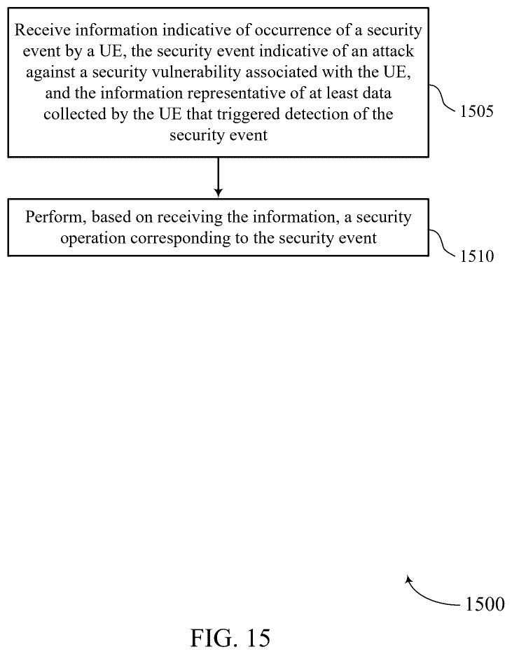

FIG. 15 shows a flowchart illustrating a method 1500 that supports techniques for security event reporting in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include receiving information indicative of occurrence of a security event by a UE, the security event indicative of an attack against a security vulnerability associated with the UE, and the information representative of at least data collected by the UE that triggered detection of the security event. The operations of 1505 may be performed in accordance with examples as disclosed herein. In some examples, aspects of the operations of 1505 may be performed by a security event indication manager 1125 as described with reference to FIG. 11.

At 1510, the method may include performing, based on receiving the information, a security operation corresponding to the security event. The operations of 1510 may be performed in accordance with examples as disclosed herein. In some examples, aspects of the operations of 1510 may be performed by a security operation manager 1130 as described with reference to FIG. 11.

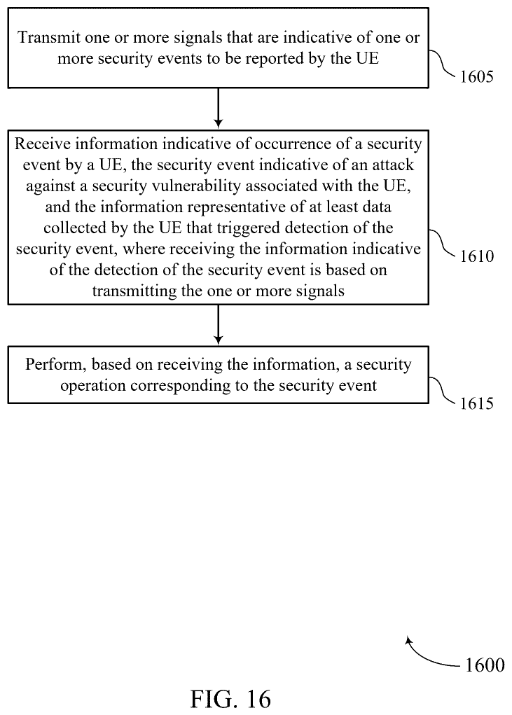

FIG. 16 shows a flowchart illustrating a method 1600 that supports techniques for security event reporting in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting one or more signals that are indicative of one or more security events to be reported by the UE. The operations of 1605 may be performed in accordance with examples as disclosed herein. In some examples, aspects of the operations of 1605 may be performed by a security event configuration manager 1135 as described with reference to FIG. 11.

At 1610, the method may include receiving information indicative of occurrence of a security event by a UE, the security event indicative of an attack against a security vulnerability associated with the UE, and the information representative of at least data collected by the UE that triggered detection of the security event, where receiving the information indicative of the detection of the security event is based on transmitting the one or more signals. The operations of 1610 may be performed in accordance with examples as disclosed herein. In some examples, aspects of the operations of 1610 may be performed by a security event indication manager 1125 as described with reference to FIG. 11.

At 1615, the method may include performing, based on receiving the information, a security operation corresponding to the security event. The operations of 1615 may be performed in accordance with examples as disclosed herein. In some examples, aspects of the operations of 1615 may be performed by a security operation manager 1130 as described with reference to FIG. 11.

The following provides an overview of aspects of the present disclosure:
Aspect 1: A method for wireless communications by a UE, comprising: detecting occurrence of a security event that is indicative of an attack against a security vulnerability associated with the UE, wherein detection of the occurrence of the security event is based at least in part on data collected by the UE; and transmitting, to a wireless entity and based at least in part on detection of the security event, information indicative of the occurrence of the security event, the information representative of at least the data collected by the UE that triggered detection of the security event.
Aspect 2: The method of aspect 1, further comprising: receiving one or more first signals that are indicative of one or more security events to be reported by the UE, wherein the data is collected by the UE based at least in part on the one or more first signals.
Aspect 3: The method of aspect 2, wherein transmitting the information indicative of the occurrence of the security event comprises transmitting, to a network entity and based at least in part on receiving the one or more signals, the data collected by the UE, and wherein the method further comprises: receiving one or more control signals from the network entity indicative of occurrence of a security threat based at least in part on transmitting the data collected by the UE.
Aspect 4: The method of any of aspects 1 through 3, further comprising: measuring, based at least in part on receiving the one or more first signals, one or more second signals, wherein the data collected by the UE is based at least in part on measuring the one or more second signals.
Aspect 5: The method of any of aspects 1 through 4, wherein detecting occurrence of the security event comprises: detecting a message, a header content, a message sequence, or a delay in accordance with an attack signature database at the UE; or detecting a difference in a signal strength, a power level, or both between contiguous signals from a network entity that satisfies a threshold difference, wherein at least one of the message, the header content, the message sequence, the delay, or the difference in the signal strength, the power level, or both is associated with the security event.
Aspect 6: The method of any of aspects 1 through 5, wherein detecting occurrence of the security event comprises: detecting a message pattern from a second wireless entity that is different than a previous message pattern form the second wireless entity, wherein the message pattern comprises a message, header content, a message sequence, or a delay.
Aspect 7: The method of any of aspects 1 through 6, wherein detecting occurrence of the security event comprises: detecting a measured state of a network entity that is inconsistent with a measured state of the UE, wherein the measured state comprises a location, a movement, a mobility, or any combination thereof.
Aspect 8: The method of any of aspects 1 through 7, wherein transmitting, to the wireless entity, the information indicative of the occurrence of the security event comprises: transmitting the information indirectly to a network entity via a sidelink communications link or via a Wi-Fi communications link, wherein the wireless entity comprises a second UE or a Wi-Fi device; or transmitting the information directly to the network entity via an uplink communications link, wherein the wireless entity comprises the network entity.
Aspect 9: The method of any of aspects 1 through 8, wherein the information indicative of the occurrence of the security event comprises a NAS or AS SMC failure, a NAS transmission failure, a count value leap, a quantity of NAS retransmissions, a quantity of TAC changes satisfying a threshold, an integrity check failure log associated with an RRC layer or a user plane, one or more broadcast messages received at the UE, or any combination thereof.
Aspect 10: The method of any of aspects 1 through 9, wherein the security event is detected via an AI model at the UE.
Aspect 11: A method for wireless communications by a network entity, comprising: receiving information indicative of occurrence of a security event by a UE, the security event indicative of an attack against a security vulnerability associated with the UE, and the information representative of at least data collected by the UE that triggered detection of the security event; and performing, based at least in part on receiving the information, a security operation corresponding to the security event.
Aspect 12: The method of aspect 11, further comprising: transmitting one or more signals that are indicative of one or more security events to be reported by the UE, wherein receiving the information indicative of the detection of the security event is based at least in part on transmitting the one or more signals.
Aspect 13: The method of aspect 12, wherein receiving the information indicative of the occurrence of the security event comprises receiving, from the UE and based at least in part on transmitting the one or more signals, the data collected by the UE, and wherein the method further comprises: detecting occurrence of a security threat that is indicative of the attack against the security vulnerability associated with the UE, wherein detection of the occurrence of the security threat is based at least in part on receiving the data collected by the UE; and transmitting one or more control signals to the UE indicative of the occurrence of the security threat based at least in part on detecting the occurrence of the security threat.
Aspect 14: The method of any of aspects 11 through 13, wherein receiving, from the UE, the information indicative of the security event comprises: receiving the information indirectly from the UE via a sidelink communications link from a second UE or via a Wi-Fi communications link from a Wi-Fi device; or receiving the information directly from the UE via an uplink communications link.
Aspect 15: The method of any of aspects 11 through 14, wherein the information indicative of the occurrence of the security event comprises a NAS or AS SMC failure, a NAS transmission failure, a count value leap, a quantity of NAS retransmissions, a quantity of TAC changes satisfying a threshold, an integrity check failure log associated with an RRC layer or a user plane, one or more broadcast messages received at the UE, or any combination thereof.
Aspect 16: The method of any of aspects 11 through 15, further comprising: identifying a security attack based at least in part on receiving the information indicative of occurrence of a security event by the UE and second information indicative of occurrences of the security event by one or more second UEs, wherein performing the security operation is based at least in part on identifying the security attack, and wherein the security operation is associated with the UE and the one or more second UEs.
Aspect 17: A UE for wireless communications, comprising one or more memories storing processor-executable code, and one or more processors coupled with the one or more memories and individually or collectively operable to execute the code to cause the UE to perform a method of any of aspects 1 through 10.
Aspect 18: A UE for wireless communications, comprising at least one means for performing a method of any of aspects 1 through 10.
Aspect 19: A non-transitory computer-readable medium storing code for wireless communications, the code comprising instructions executable by one or more processors to perform a method of any of aspects 1 through 10.
Aspect 20: A network entity for wireless communications, comprising one or more memories storing processor-executable code, and one or more processors coupled with the one or more memories and individually or collectively operable to execute the code to cause the network entity to perform a method of any of aspects 11 through 16.
Aspect 21: A network entity for wireless communications, comprising at least one means for performing a method of any of aspects 11 through 16.
Aspect 22: A non-transitory computer-readable medium storing code for wireless communications, the code comprising instructions executable by one or more processors to perform a method of any of aspects 11 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
detect occurrence of a security event that is indicative of an attack against a security vulnerability associated with the UE, wherein detection of the occurrence of the security event is based at least in part on data collected by the UE; and
transmit, to a wireless entity and based at least in part on detection of the security event, information indicative of the occurrence of the security event, the information representative of at least the data collected by the UE that triggered detection of the security event.

2. The UE of claim 1, wherein the one or more processors are individually or collectively further operable to execute the code to cause the UE to:
receive one or more first signals that are indicative of one or more security events to be reported by the UE, wherein the data is collected by the UE based at least in part on the one or more first signals.

3. The UE of claim 2, wherein, to transmit the information indicative of the occurrence of the security event, the one or more processors are individually or collectively further operable to execute the code to cause the UE to transmit, to a network entity and based at least in part on receiving the one or more signals, the data collected by the UE, and the one or more processors are individually or collectively further operable to execute the code to cause the UE to:
receive one or more control signals from the network entity indicative of occurrence of a security threat based at least in part on transmitting the data collected by the UE.

4. The UE of claim 2, wherein the one or more processors are individually or collectively further operable to execute the code to cause the UE to:
measure, based at least in part on receiving the one or more first signals, one or more second signals, wherein the data collected by the UE is based at least in part on measuring the one or more second signals.

5. The UE of claim 1, wherein, to detect occurrence of the security event, the one or more processors are individually or collectively operable to execute the code to cause the UE to:
detect a message, a header content, a message sequence, or a delay in accordance with an attack signature database at the UE; or
detect a difference in a signal strength, a power level, or both between contiguous signals from a network entity that satisfies a threshold difference, wherein at least one of the message, the header content, the message sequence, the delay, or the difference in the signal strength, the power level, or both is associated with the security event.

6. The UE of claim 1, wherein, to detect occurrence of the security event, the one or more processors are individually or collectively operable to execute the code to cause the UE to:
detect a message pattern from a second wireless entity that is different than a previous message pattern form the second wireless entity, wherein the message pattern comprises a message, header content, a message sequence, or a delay.

7. The UE of claim 1, wherein, to detect occurrence of the security event, the one or more processors are individually or collectively operable to execute the code to cause the UE to:
detect a measured state of a network entity that is inconsistent with a measured state of the UE, wherein the measured state comprises a location, a movement, a mobility, or any combination thereof.

8. The UE of claim 1, wherein, to transmit, to the wireless entity, the information indicative of the occurrence of the security event, the one or more processors are individually or collectively operable to execute the code to cause the UE to:
transmit the information indirectly to a network entity via a sidelink communications link or via a Wi-Fi communications link, wherein the wireless entity comprises a second UE or a Wi-Fi device; or
transmit the information directly to the network entity via an uplink communications link, wherein the wireless entity comprises the network entity.

9. The UE of claim 1, wherein the information indicative of the occurrence of the security event comprises a non-access stratum (NAS) or access stratum (AS) security mode control (SMC) failure, a NAS transmission failure, a count value leap, a quantity of NAS retransmissions, a quantity of tracking area code (TAC) changes satisfying a threshold, an integrity check failure log associated with a radio resource control (RRC) layer or a user plane, one or more broadcast messages received at the UE, or any combination thereof.

10. The UE of claim 1, wherein the security event is detected via an artificial intelligence (AI) model at the UE.

11. A network entity, comprising:
one or more memories storing processor-executable code; and
one or more processors coupled with the one or more memories and individually or collectively operable to execute the code to cause the network entity to:
receive information indicative of occurrence of a security event by a user equipment (UE), the security event indicative of an attack against a security vulnerability associated with the UE, and the information representative of at least data collected by the UE that triggered detection of the security event; and
perform, based at least in part on receiving the information, a security operation corresponding to the security event.

12. The network entity of claim 11, wherein the one or more processors are individually or collectively further operable to execute the code to cause the network entity to:
transmit one or more signals that are indicative of one or more security events to be reported by the UE, wherein receiving the information indicative of the detection of the security event is based at least in part on transmitting the one or more signals.

13. The network entity of claim 12, wherein, to receive the information indicative of the occurrence of the security event, the one or more processors are individually or collectively further operable to execute the code to cause the network entity to receive, from the UE and based at least in part on transmitting the one or more signals, the data collected by the UE, and the one or more processors are individually or collectively further operable to execute the code to cause the network entity to:
detect occurrence of a security threat that is indicative of the attack against the security vulnerability associated with the UE, wherein detection of the occurrence of the security threat is based at least in part on receiving the data collected by the UE; and
transmit one or more control signals to the UE indicative of the occurrence of the security threat based at least in part on detecting the occurrence of the security threat.

14. The network entity of claim 11, wherein, to receive, from the UE, the information indicative of the security event, the one or more processors are individually or collectively operable to execute the code to cause the network entity to:
receive the information indirectly from the UE via a sidelink communications link from a second UE or via a Wi-Fi communications link from a Wi-Fi device; or
receive the information directly from the UE via an uplink communications link.

15. The network entity of claim 11, wherein the information indicative of the occurrence of the security event comprises a non-access stratum (NAS) or access stratum (AS) security mode control (SMC) failure, a NAS transmission failure, a count value leap, a quantity of NAS retransmissions, a quantity of tracking area code (TAC) changes satisfying a threshold, an integrity check failure log associated with a radio resource control (RRC) layer or a user plane, one or more broadcast messages received at the UE, or any combination thereof.

16. The network entity of claim 11, wherein the one or more processors are individually or collectively further operable to execute the code to cause the network entity to:
identify a security attack based at least in part on receiving the information indicative of occurrence of a security event by the UE and second information indicative of occurrences of the security event by one or more second UEs, wherein performing the security operation is based at least in part on identifying the security attack, and wherein the security operation is associated with the UE and the one or more second UEs.

17. A method for wireless communications by a user equipment (UE), comprising:
detecting occurrence of a security event that is indicative of an attack against a security vulnerability associated with the UE, wherein detection of the occurrence of the security event is based at least in part on data collected by the UE; and
transmitting, to a wireless entity and based at least in part on detection of the security event, information indicative of the occurrence of the security event, the information representative of at least the data collected by the UE that triggered detection of the security event.

18. The method of claim 17, further comprising:
receiving one or more first signals that are indicative of one or more security events to be reported by the UE, wherein the data is collected by the UE based at least in part on the one or more first signals.

19. The method of claim 18, wherein transmitting the information indicative of the occurrence of the security event comprises transmitting, to a network entity and based at least in part on receiving the one or more signals, the data collected by the UE, and wherein the method further comprises:
receiving one or more control signals from the network entity indicative of occurrence of a security threat based at least in part on transmitting the data collected by the UE.

20. The method of claim 18, further comprising:
measuring, based at least in part on receiving the one or more first signals, one or more second signals, wherein the data collected by the UE is based at least in part on measuring the one or more second signals.
